(19) United States
(12) Patent Application Publication
(10) Pub. No.: US 2007/0279187 A1
(43) Pub. Date: Dec. 6, 2007

(54) Patient information storage and access

(76) Inventors: Shahrooz Hekmatpour, Boxford, MA (US); Brian Cruz, Sudbury, MA (US); Shahram Hekmatpour, Canterbury (AU)

Correspondence Address: MCDERMOTT WILL & EMERY LLP, 28 STATE STREET, BOSTON, MA, 02109-1775, US

(21) Appl. No.: 11/786,504

(22) Filed: Apr. 12, 2007

Related U.S. Application Data
(60) Provisional application No. 60/791,490, filed on Apr. 12, 2006.

(51) Int. Cl. G05B 19/00

(52) U.S. Cl. 340/5.83; 340/5.82; 705/3; 340/5.74; 235/375; 382/124

(57) ABSTRACT

Systems for and methods of providing secure access to and storing patient medical information are described. In accordance with one aspect a method is described as a method of providing secure access to stored medical information regarding at least one subject, comprising: accepting unique biometric information from a subject; accepting a command from a user for accessing at least a portion of a medical record associated with the subject, the subject's medical record identified using the subject's biometric information; accessing at least the portion of the medical record securely; and executing the user's command on at least the portion of the medical record. In accordance with another aspect a system a system is configured to provide secure access to medical information regarding at least one subject, comprising: a first input configured to accept unique biometric information from a subject; a second input configured to accept a command from a user for accessing at least a portion of a medical record associated with the subject, the subject's medical record identified using the subject's biometric information; and an access device configured so as to access at least the portion of the medical record securely in response to the execution of a user's command.

The present application for patent claims priority to Provisional Application No. 60/791,490 entitled “Unifile Healthcare Management System” filed Apr. 12, 2006, and assigned to the assignee hereof and hereby expressly incorporated by reference herein.

### BACKGROUND

1. Field

The presently disclosed embodiments relate generally to patient and healthcare information identification, storage, and retrieval, and more specifically to apparatus and methods for secured patient identification, and information storage and access.

2. Background

The quality of care offered to patients (subjects) by healthcare providers is largely dependent on the quality and completeness of patient information available at the time. Because patient medical information often is fragmented across multiple organizations and held in a variety of formats (paper-based and electronic), inefficiencies arise that may adversely affect the care provision process. For example, basic patient information (such as blood type and drug prescriptions) is often collected multiple times by different practitioners. Furthermore, due to the lack of electronic sharing of information, requesting patient information by one party (e.g., HMO) from another (e.g., physician) is typically lengthy, labor-intensive, and costly. The impact of these inefficiencies is particularly significant in emergency situations (e.g., an unconscious car accident victim).

Methods have been proposed to facilitate the sharing of patient information in electronic format. These methods typically involve the storing of patient information in a centralized database and/or using a device, such as a smart card issued to patients, to store personal details and important medical facts (such as blood type, immunization history, and drug prescriptions).

There are many practical drawbacks to these approaches. Lack of an open design for a centralized database imposes significant constraints on access. Use of a software application designed specifically to interact with the central database is typically how the information is accessed. This results in lower take-up by the health industry which, in turn, diminishes the value of the central database. This proprietary design approach also creates considerable fragmentation in the healthcare industry. Often, even hospitals across the street from each other use different medical databases and software applications for accessing these databases so that and data transfer between various hospitals is costly and time consuming.

Another drawback is the use of security devices (such as smart cards) which are easily lost or may be unavailable when needed. This hampers access to vital medical information, especially in emergency situations. Further, the information on these devices can be compromised such as if they were lost or stolen.

There is therefore a need in the art for techniques and architecture to securely access patient information with high availability and minimal information fragmentation or inconsistencies.

### SUMMARY

Techniques for securely storing and accessing patient information, and for patient identification are described herein.

In accordance with one aspect a method of providing secure access to stored medical information regarding at least one subject, comprises: accepting unique biometric information from a subject; accepting a command from a user for accessing at least a portion of a medical record associated with the subject, the subject's medical record identified using the subject's biometric information; accessing at least the portion of the medical record securely; and executing the user's command on at least the portion of the medical record.

In accordance with another aspect a method of securely storing subject information, comprising: using one or more databases to securely store subject biometric information, subject information, and user authentication information; accepting unique biometric information from a subject; accepting a command from a user for accessing at least a portion of a record associated with the subject, the record stored in the subject information database, the subject's medical record identified using the subject's biometric information stored on the subject biometric information database; accessing at least the portion of the medical record securely using the user authentication information; and executing the user's command on at least the portion of the medical record.

In accordance with yet another aspect a system configured to provide secure access to medical information regarding at least one subject, comprises: a first input configured to accept unique biometric information from a subject; a second input configured to accept a command from a user for accessing at least a portion of a medical record associated with the subject, the subject's medical record identified using the subject's biometric information; and an access device configured so as to access at least the portion of the medical record securely in response to the execution of a user's command.

In accordance with still another aspect a system configured to secure access to medical information regarding at least one subject, comprises: at least one database configured to store subject biometric information, subject information, and user authentication information; a first input configured to accept unique biometric information from a subject; a second input configured to accept a command from a user for accessing at least a portion of a record associated with the subject, the record stored in the subject information database, the subject's medical record identified using the subject's biometric information stored on the subject biometric information database; and an access device configured to allow secure access to at least the portion of the medical record using the user authentication information in response to the execution of the user's command on at least the portion of the medical record.

Various aspects and embodiments of the invention are described in further detail below.

### BRIEF DESCRIPTION OF THE DRAWINGS

FIG. 1 is a block diagram of an exemplary embodiment of a healthcare management system;

FIG. 2 is a block diagram of an exemplary embodiment of a software architecture of an information server of the healthcare management system;

FIG. 3 is a block diagram of an exemplary embodiment of a information client of the healthcare management system;

FIG. 4 is a frontal view of an exemplary embodiment of an information client device;

FIG. 5 is a rear view of the embodiment shown in FIG. 4;

FIG. 6 is a perspective view of an exemplary embodiment of a cradle for use with the embodiment of the information client device shown in FIGS. 4 and 5;

FIG. 7 is a perspective view of an exemplary embodiment of a client system;

FIG. 8 is a block diagram of an exemplary embodiment of components of the information client device;

FIG. 9 is a block diagram of an exemplary embodiment of components of the information client device;

FIG. 10 is a flow diagram illustrating a typical use of the healthcare management system; and

FIG. 11 is a flow diagram illustrating a second typical use of the healthcare management system.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

The record access techniques described herein may be used for various applications such as retrieving and writing to patient records, medical history, drugs and medication history, drug allergies, and so on.

The transmission medium described herein may be a wireless or wired communication system or a combination of both. Communication and transmission systems include cellular systems, broadcast systems, wireless local area network (WLAN) systems, Wi-Fi systems, LAN, Internet, and so on, as well as a wide area network (WAN) system used to access a secured network.

Generally, interfaces with a transmission medium include hardware and software interfaces. Hardware interfaces described herein include wireless broadcast antennas, RJ-45 connectors, DB-9, hermaphroditic connectors, and so on. Software interfaces include TCP/IP, NetBEUI, XMODEM, IPX, MODEM7, token ring, and so on.

Block diagrams described herein may be implemented using any known methods of implementing computational logic. Examples of methods of implementing computational logic include use of field-programmable gate arrays (FPGA), application-specific integrated circuits (ASIC), complex programmable logic devices (CPLD), integrated optical circuits (IOC), microprocessors, and so on.

The generalization of this healthcare management architecture, also within the scope of this disclosure, can incorporate other stage orders and combinations. For example, some embodiments of the healthcare management architecture may incorporate additional layers of security and authentication protocols or techniques.

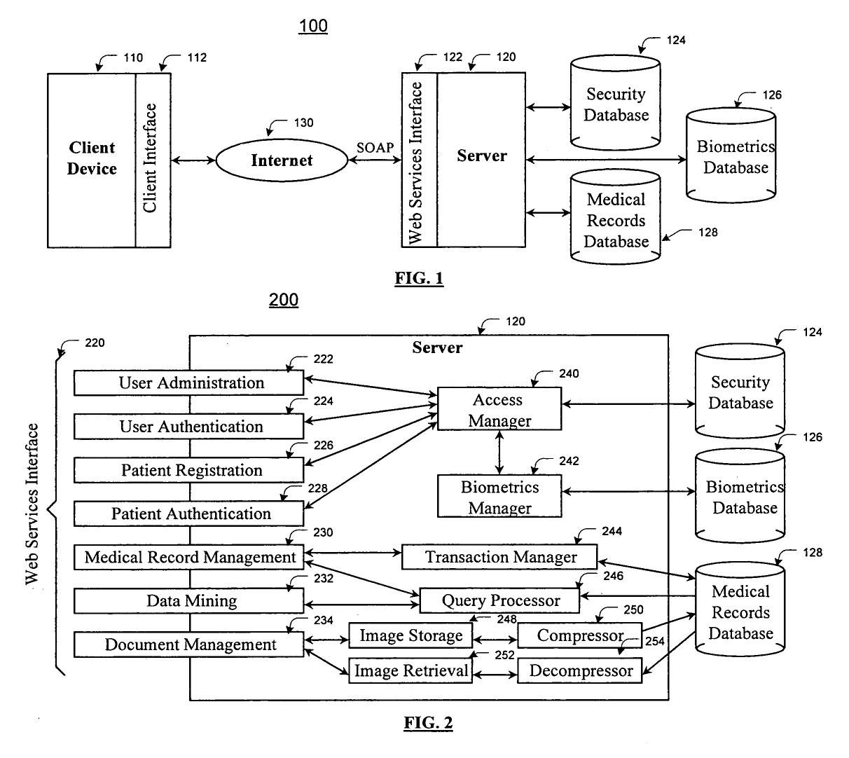

Referring to FIG. 1, an exemplary embodiment of a healthcare management system is shown. In some embodiments of a healthcare management system 100, such as the one illustrated in FIG. 1, the healthcare management system's architecture is structured as a client-server model. Other embodiments also within the scope of this disclosure include other computer architectures and computer network architectures such as a peer-to-peer network, and so on.

Referring to the exemplary embodiment of the healthcare management system 100 shown in FIG. 1, the system includes a client 110 (via a client interface 112) connected to a server 120 (via a server interface 122) over a transmission medium 130 such as the Internet. The server 120 acts as a central repository for maintaining patient medical information and oversees access to three separate databases 124, 126, 128, a security database 124, a biometrics database 126, and a medical records database 128. Through the server 120, the client 110 may access to three underlying database 124, 126, 128.

The security database 124 typically stores details of individuals (users) who can access the system 100, including type, name, profession, user ID, password, contact details, access privileges, and so on. Healthcare professionals as well as patients are usually captured in this database. Patients are typically not allowed direct access to the system 100 and, therefore, are not provided with a password, although permission from the patients for accessing the individual patients records would likely be necessary under current HIPAA rules and regulations. Passwords in the security database 124 are usually stored in encrypted format.

The biometrics database 126 stores personal and unique biometric information for each patient, such as fingerprint images and pre-analyzed fingerprint data. Typically, personal information (such as name or address) of the patient is not stored in this database, unless it is considered necessary for the particular application. Instead, a unique numeric identifier is usually used to link records in the security database 124 to corresponding images in the biometrics database 126.

The medical records database 128 stores medical information for each patient, such as medical history, hospital records, administered drugs, x-rays, MRI scans, and so on. Typically, personal patient information is not stored in this database either, unless it is considered necessary for the particular application. A unique numeric identifier is also usually used to link records in the security database 124 to corresponding records in the medical database 128.

The use of a plurality of databases to store information is more desirable since such an architecture enhances security and availability. Should intruders or computer viruses gain access to one database, the data integrity and availability of the others remains intact.

The server 120 makes its services available through a Web Services Interface 122. This interface 122 can be accessed by a variety of client devices 110 across the Internet 130 using a suitable protocol, as for example Simple Object Access Protocol (SOAP). SOAP is a technology for invoking methods of remote objects in Internet-based client-server applications. Client devices 110 use a client interface 112 to establish an asynchronous connection with the server 120. Through this connection, client devices 110 may exchange information with the server 120. This architecture decouples the design of client devices from the server 120 enabling third-party suppliers to create new client devices that will inter-operate with the server 120. Examples of client devices 110 are described in later figures.

For security, data exchanged between a client 110 and the server 120 is typically transported via HTTPS and is usually subject to encryption, such as 128-bit encryption. In other embodiments, other transport protocols and/or encryption techniques are possible and are within the scope of this disclosure.

This approach of using patient biometrics (e.g. fingerprints) avoid the problems associated with smart cards, and allows medical care professionals to access patient data in the event of emergencies when the patient can not communicate.

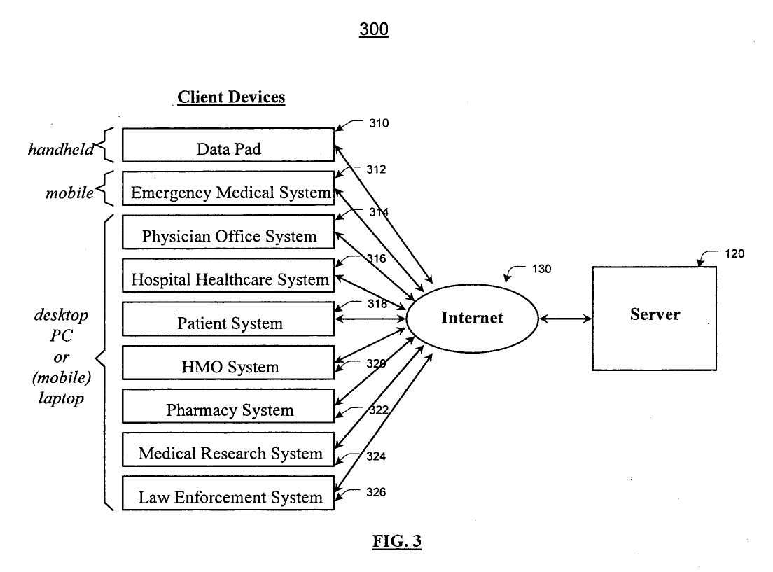

Referring to FIG. 2, an example of basic modules of a software architecture 200 of the server 120 are shown. A web services interface 220 provided by the server 120 comprises one or more of the following or similar services:

User administration 222 supports creation of new users and modification of existing users. It verifies that the connected user has the necessary administrative access privileges to perform these operations. A newly-created user is usually assigned a user ID and password for accessing the system. The password may be user chosen at the time of the account creation.

User authentication 224 supports a user login process. Users may login using a user ID and password (typically for computer based users) or scanned fingerprint or other biometric image (typically for data pad users, a device further described in subsequent figures).

Patient registration (subject registration) 226 supports registration of new patients and modification of existing patients. Personal patient information (including biometric information such as a fingerprint image) is captured and stored in the system 200.

Patient authentication 228 supports authentication of a patient using a scanned fingerprint or other biometric information. Once a patient is authenticated using the biometric information, the current user (e.g. practitioner) is granted access to the patient's medical information.

Medical record management 230 supports storage and retrieval of patient records. If the patient has been authenticated and the current user has appropriate access privileges through his/her unique access information, using for example his/her biometric information, then the patient's medical records can be accessed and information can be added to it in a secure manner.

Data mining 232 supports searching of medical records in anonymous format (i.e., without patient personal information). This can, for example, be used to generate statistical clinical reports for research purposes.

Document management 234 supports storage and retrieval of document images (e.g., x-rays, MRI scans, scanned paper documents) as a part of the process of updating a patient's medical records.

An access manager module 240 controls retrievals and updates of the security database 124. If access involves biometrics information, this is handled by a biometrics manager module 242, which controls retrievals and updates of the biometrics database 126. The biometrics manager 242 also performs recognition of the biometric information, such as a finger print image, during an authentication process. The techniques and algorithms for fingerprint recognition are known to those skilled.

A transaction manager module 244 handles updates for the medical records database 128, and ensures the atomicity, consistency, isolation, and durability (ACID properties) of transactions, such that concurrent updates by multiple users are correctly handled. The query processor module 246 handles read-only access to the medical records database 128.

An image storage module 248 and compressor module 250 handle adding of images to the medical records database 128. Each image is usually indexed by a unique ID and compressed before being stored. Conversely, an image retrieval 252 and decompression 254 modules typically handle retrieval of an image (using its ID) and decompress the image before passing it on.

Referring to FIG. 3, an illustrative range 300 of client devices 110 which can connect to and exchange information with the server 120 is shown. A data pad 310 is a specialized handheld device designed for use in medical facilities, such as hospital, clinics, and emergency rooms. This device 310 is compact and may be carried by a practitioner while attending to a patient's needs (see FIG. 4). In other embodiments, the data pad may be implemented as software incorporated into PDAs with fingerprint scanning capabilities as well as add-on attachments to PDAs.

An emergency medical system 312 is an example of a mobile client device, suitable for use in an ambulance, for example. The hardware platform in this case may be a laptop computer with wireless Internet access.

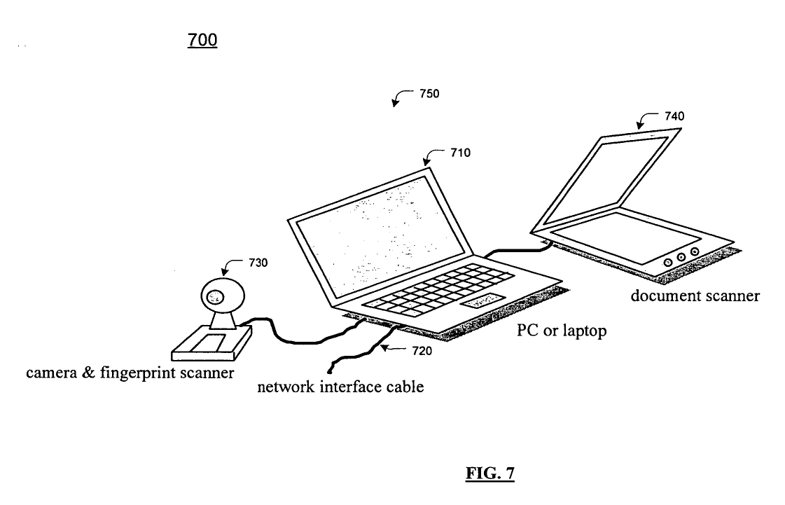

Remaining client devices 314-326 are all PC or laptop based, typically operated on a desk in office environment (see FIG. 7). The physician office system 314 enables doctors to register new patients and keep their medical records up-to-date in subsequent visits. One benefit here is instantaneous access to a patient's full medical records, regardless of geographic location and without having to request paper-based medical records from other organizations.

A hospital healthcare system 316 and patient system 318 are examples of existing administrative systems in hospitals and clinics, which can be extended to act as client devices 110.

A HMO system 320 provides HMOs and health insurance companies electronic access to medical records, thus eliminating the costly and time-consuming process of having to obtain paper-based medical records from individual facilities.

A pharmacy system 322 streamlines drug prescription process. Pharmacy staff can access up-to-date prescription records for a patient, without having to call a physician to verify unreadable or suspect prescriptions. The system 322 can also help track those abusing, are known to abuse, or have a potential to abuse prescription drugs. For example, certain drugs have a higher incidence of abuse and the pharmacy system 322 can help monitor patients on those medications.

A medical research system 324 and law enforcement system 326 are examples of systems that can use data mining to look for information patterns in large population samples, without compromising patients' identifies and privacy.

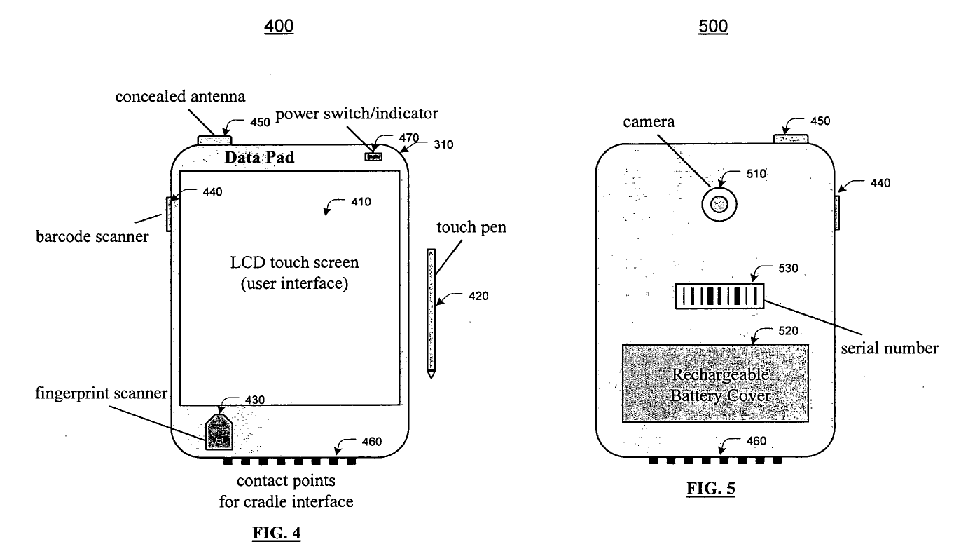

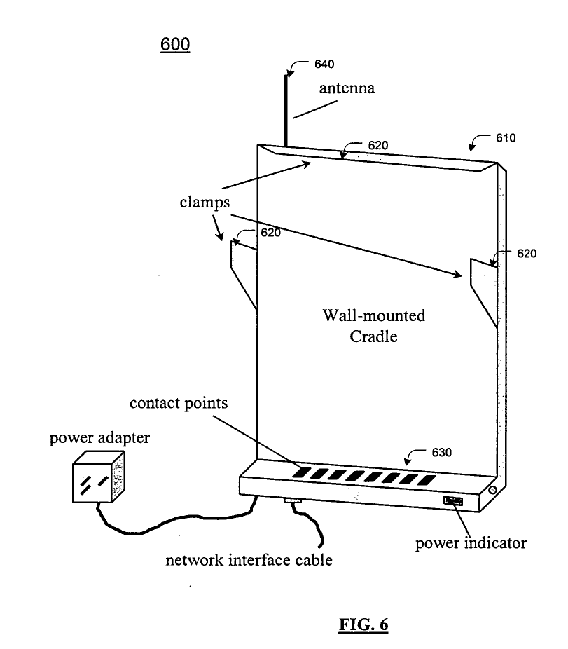

Referring to FIGS. 4 and 5, a front 400 and a back 500 view of a data pad (DP) 310 are respectively shown. FIG. 6 refers to a cradle housing system 600 for the device 310. In this exemplary embodiment, the data pad 310 is used by physicians and is installed in medical facilities (such as hospitals and clinics) where patients are examined and cared for. In other embodiments, the data pad may be used by other users and/or in other settings. Continuing with this embodiment, the device 310 is wall-mounted using a cradle 610 (see FIG. 6). DP 310 is wireless and uses radio signals to communicate with its cradle 610 which, in turn, is Internet-enabled through a Local Area Network (LAN) connection. The wireless communication employs an antenna 450 which may or may not be concealed depending on the embodiment or implementation.

The DP 310 has a Liquid Crystal Display (LCD) screen 410 which is touch sensitive. The screen typically functions acts as both output and input devices. A touch pen 420 is provided so that the user can accurately point and click on tokens displayed on the LCD, thus invoking functions. Tokens are understood by those skilled to include icons, images, words, features, and so on. Additionally, the DP 310 has a fingerprint scanner 430. During an authentication process, the screen 410 prompts the user to place their index finger on the scanner 430. A short beep confirms the completion of the scanning. A barcode scanner 440, positioned on the side of the device, allows users to quickly enter IDs (e.g., user ID, document ID) by scanning a barcode rather than entering it alphanumerically. In addition, or as an alternative, an input device, such as a keyboard can be provided for aiding in the entering and accessing of information. The user may enter information via the touch screen by clicking on tokens, employing graffiti, or employing handwritten character recognition.

A small camera 510 can be positioned at the back of the device and can be used to take photographs. This is useful during the patient registration process, where a facial photograph of the patient is required. It is also useful when the physician needs to record visual information (e.g., injuries suffered in an accident). In some embodiments, the camera may also be used for patient or user identification. For example, the camera may be used for iris recognition, facial recognition, and so on. Further, these various methods of patient/user recognition may be used in combination to better positively identify the individual.

The DP 310 has a serial number 530 to identify the specific unit. The serial number can be used to identify the specific unit making command requests as well as identify units in need of repair or user attention. The DP 310 has a power switch-power indicator 470 to indicate that it is on.

The DP 310 can be powered by a rechargeable battery 520. While the device is not in use, it can be placed in its cradle 610 to recharge. One or more attachments (e.g. clamps 620) around a cradle 610 keep the device 310 securely in place and ensure that the contact points 460 on the device 310 and contact points 630 cradle 610 align correctly. When secured in its cradle 610, the device 310 may communicate with the cradle 610 through the contact points 460 630 rather than radio signals via an antenna 640.

In some embodiments, operation of the DP 310 can include one or more of the following or similar illustrative steps.
A physician removes the DP 310 from its cradle 610. At this point, the device 310 is automatically switched on, and displays a logo and the organization at which it is installed.
The user is prompted to login to the device 310. The device 310 cannot be operated without authentication and may include an inactivity time out where the user is required to log in again. The user can either input a user ID and password (using the touch pen) or place a finger on the fingerprint scanner. A short beep is emitted upon successful authentication, and the device 310 displays the list of functions available to the user. The latter is dependent on the user's access privileges.
To access a patient's medical records, the user chooses the patient authentication function and, for example, asks the patient to place their right index finger on the fingerprint scanner. Upon successful patient authentication, the screen displays the patient's records as a menu. The user can navigate through patient information by drilling down this menu. The user can also add to patient's records by entering new information.
Once the physician has finished with the patient, s/he will choose the exit function, which will clear the patient menu from the screen. Accessing the records of this patient or another patient will require authentication (e.g. fingerprint). Additionally, the device will have a timeout function which, after a period of inactivity, will automatically require re-authentication.
To register a new patient, the physician chooses the ‘register new patient’ function. The device then prompts the user to enter patient's personal details, scan the patient's fingerprint, and capture a photograph of the patient's face. The user can then review the entered information and choose the ‘submit’ function to complete the registration process. Alternatively, the information can be entered into a computer or other input device, and subsequently downloaded to the DP, as described below in connection with FIG. 7.
If the user leaves the DP idle for 5 minutes or places it back in its cradle, the device will auto-logout. Subsequent use will require user authentication.

Referring to FIG. 7, a client system 700 (e.g., physician office system) deployed on conventional hardware is shown. The PC 710 is connected to the Internet 130 via a network interface 720 (or modem) and runs client software. It is also connected to a camera/fingerprint scanner 730 and a document scanner 740. The user interface provided by this system 700 would be similar to the DP 310, but because this setup includes a conventional keyboard, it is better suited to entering a lot of textual information, as well as adding scanned documents to a patient's records. The use of camera and fingerprint scanner 730 is similar to the DP 310 scenario and supports the registration and authentication processes.

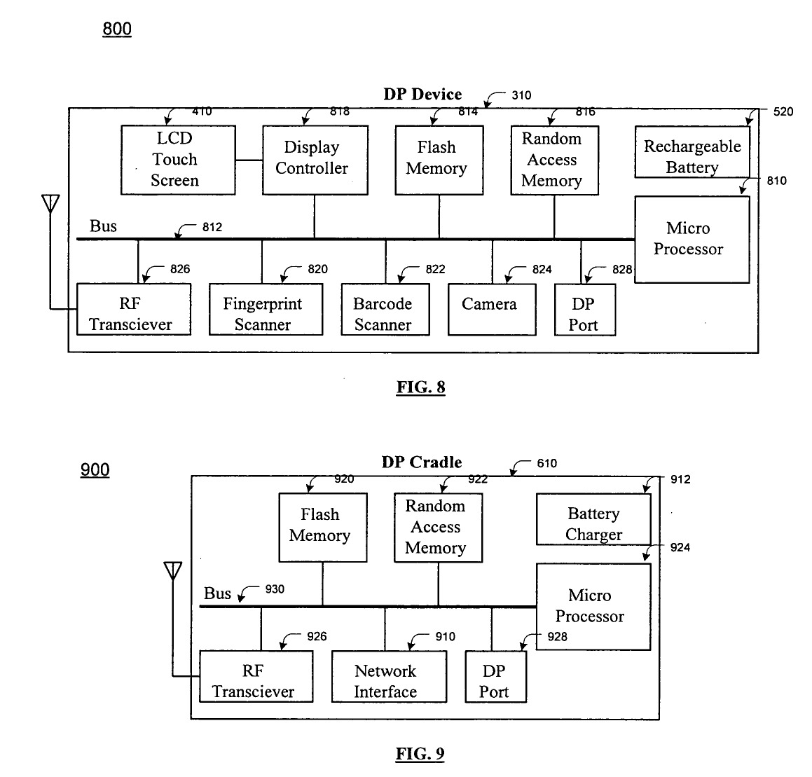

Referring to FIG. 8, an exemplary design 800 of the DP 310 is shown. The device 310 is driven by a microprocessor 810 connected to a bus 812 to communicate with various components. In some embodiments, the device 310 utilizes two types of memory: a flash memory 814 stores the client software deployed on the device 310, and the random access memory 816 stores transient information when the device is in use. In other embodiments, different types of memories are used and it is within the scope of this disclosure. The software can be upgraded by storing a newer version in flash memory 814, or replacing the flash memory chip. A display controller 818 manages the display of digital data on the LCD Touch Screen 410, and passes input operations back to the software.

A fingerprint scanner 820, barcode scanner 822, and camera 824 are examples of input devices and can be implemented in various embodiments. Examples include the scanners in previously described figures. An RF transceiver 826 translates requests raised by the DP 310 into radio signals and sends them to the DP Cradle 610. It also does the reverse by translating information returned by the cradle 610 as radio signals back into their original format.

A DP port 828 provides a physical interface between the DP 310 and its cradle 610.

Referring to FIG. 9, an exemplary design 900 of the DP cradle 610 is shown. The DP cradle 610 has a similar (but simpler) design to the DP 310. The software deployed within the cradle manages translation of data exchanged between the cradle 610 and the DP 310, to/from radio signals and SOAP requests. When the DP 310 is secured in its cradle 610, radio signals are not used and the communication is direct over the contact points 630 (in other embodiments, the radio signals may still be used). In both cases, however, the cradle software implements the client interface 112 (see FIG. 1) to communicate with the server 120. A network interface 910 provides the necessary Internet connectivity. A battery charger 912 manages the recharging of the DP battery 520 when it is secured in its cradle 610.

The DP cradle 610 also includes various memories 920 922, a microprocessor 924, an RF transceiver 926, a DP port 928, and a bus 930 connected these various modules.

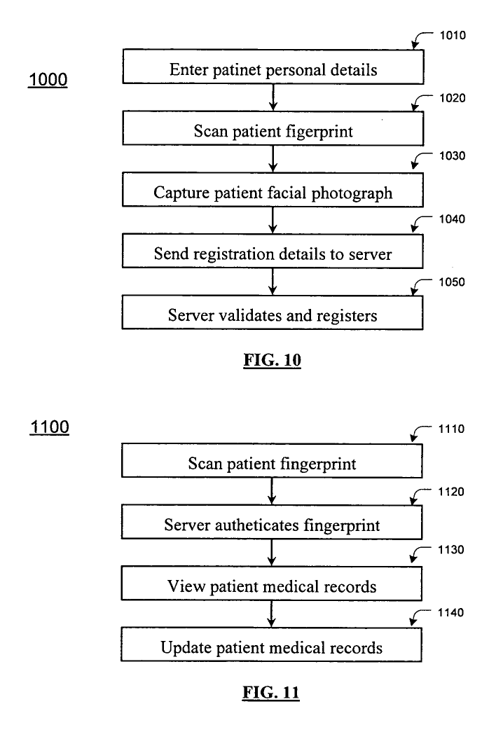

Referring to FIG. 10, an exemplary embodiment of a patient registration process 1000 as exercised by a physician or other health care professional using a client device is shown. The patient is interviewed by the physician who then enters the patient personal details into the system (step 1010). Next the physician is prompted by the system to scan the patient's fingerprint and capture a facial photograph (steps 1020 and 1030). This information is then submitted to the server (step 1040). The latter validates the information by cross-checking it against the information it has already in store (step 1050). For example, if the patient is already registered in the database, the new registration will be rejected. Once validates, the server permanently stores the patient details for subsequent use.

Referring to FIG. 11, a process 1100 for a subsequent visit by a registered patient is shown. The physician scans the patient fingerprint (step 1110). The server compares the fingerprint image against the registered patients and retrieves the records of the matching patient, if any (step 1120). The physician can view these records (step 1130) and, as a result of the consultation, add new information (step 1140).

Information added to the system (during registration or subsequent consultation) is immediately available to other users (although a delay can be incorporated in some embodiments). Because the system operates over the Internet, the information can be instantaneously accessed anywhere in the world.

This healthcare management system provides healthcare professional with a range of remote units (client devices) to access patient medical records maintained in a secure central system (server) over the Internet. The server provides a range of web services, through a well-defined interface, such that new client devices can be added by third-party providers. Security measures such as patient biometrics and data encryption are used to secure the whole system against unauthorized access.

The healthcare management system can also be used as an effective advertising tool, with paid advertising services offered to, for example, pharmaceutical companies. The advertising mode can be configured to kick in when the device has been idle for a pre-specified length of time and/or when user places the device in its cradle. Examples of two advertising formats that can be supported:
Full graphics and hyper-linked pages rendered in HTML, allowing the use to interact with the ads and drill down to the advertisers web site for more information.
Ticker-tape information running at the bottom of the screen, providing up-to-the-minute accurate information about the latest medical and pharmaceutical alerts.

The healthcare management system described addresses these difficulties by promoting a central system that has an open design, thus making it feasible for third-party software and hardware developers to offer applications and devices that can access the central system, in a secure manner, and exchange information with it. Further, this approach of using patient biometrics (e.g. fingerprints) avoid the problems associated with smart cards, and allows medical care professionals to access patient data in the event of emergencies when the patient can not communicate.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of providing secure access to stored medical information regarding at least one subject, comprising:
accepting unique biometric information from a subject;
accepting a command from a user for accessing at least a portion of a medical record associated with the subject, the subject's medical record identified using the subject's biometric information;
accessing at least the portion of the medical record securely; and
executing the user's command on at least the portion of the medical record.

2. The method in claim 1, wherein the subject medical record includes a medical history.

3. The method in claim 1, wherein accepting the biometric information from a subject includes scanning a biometric image from the subject.

4. The method in claim 1, wherein the biometric information is a biologically unique marker.

5. The method in claim 4, wherein the biologically unique marker is a fingerprint.

6. The method in claim 4, wherein the biologically unique marker is a photograph of the subject.

7. The method in claim 4, wherein the biologically unique marker is a combination of multiple biologically unique markers.

8. The method in claim 1, further comprising identifying the associated record using the accepted biometric information.

9. The method in claim 8, wherein the identification of the associated record includes matching the accepted biometric information with a biometric record associated with the subject.

10. The method in claim 1, wherein securely accessing the medical record includes authenticating the user prior to executing the user's command.

11. The method in claim 1, further comprising one or more databases storing subject biometric information, subject information, and user authentication information.

12. The method in claim 11, wherein the database is centrally stored.

13. The method in claim 11 wherein the database comprises three databases, a subject biometric information database, a subject information database, and a user authentication information database.

14. The method in claim 11, wherein one or more of the databases is encrypted.

15. The method in claim 1, wherein the subject information is accessed over a telecommunication channel.

16. The method in claim 1, wherein the command includes a read request.

17. The method in claim 1, wherein the command includes a write request.

18. The method in claim 1, wherein the command is received on a device containing a processor.

19. A method of securely storing subject information, comprising:
using one or more databases to securely store subject biometric information, subject information, and user authentication information;
accepting unique biometric information from a subject;
accepting a command from a user for accessing at least a portion of a record associated with the subject, the record stored in the subject information database, the subject's medical record identified using the subject's biometric information stored on the subject biometric information database;
accessing at least the portion of the medical record securely using the user authentication information; and
executing the user's command on at least the portion of the medical record.

20. A system configured to provide secure access to medical information regarding at least one subject, comprising:
a first input configured to accept unique biometric information from a subject;
a second input configured to accept a command from a user for accessing at least a portion of a medical record associated with the subject, the subject's medical record identified using the subject's biometric information; and
an access device configured so as to access at least the portion of the medical record securely in response to the execution of a user's command.

21. The system in claim 20, wherein the subject's medical record includes a medical history.

22. The system in claim 20, wherein the first input includes a scanner configured to scan a biometric image from the subject.

23. The system in claim 20, wherein the biometric information is a biologically unique marker.

24. The system in claim 23, wherein the first input includes a fingerprint reader.

25. The system in claim 23 wherein the first input includes a camera.

26. The system in claim 23, wherein the biologically unique marker is a combination of multiple biologically unique markers.

27. The system in claim 20, wherein the system is further configured to identify the associated record using the accepted biometric information.

28. The system in claim 27, wherein the identification of the associated record includes matching the accepted biometric information with a biometric record associated with the subject.

29. The system in claim 20, wherein the system is further configured so as to authenticate the user in response to the command provided at the second input prior to executing the user's command.

30. The system in claim 20, further comprising at least one database configured so as to store subject biometric information, subject information, and user authentication information.

31. The system in claim 30, wherein the database is centrally stored.

32. The system in claim 30, wherein the database comprises a subject biometric information database, a subject information database, and a user authentication information database.

33. The system in claim 31, wherein the database is configured so as to store encrypted information.

34. The system in claim 20, further including a transmitter/receiver so that the subject information is accessed over a telecommunication channel.

35. The system in claim 20, wherein the second input is configured so that command includes a read request.

36. The system in claim 20, wherein the second input is configured so that command includes a write request.

37. The system in claim 20, wherein the second input is coupled to a processor configured to process the command.

38. A system configured to secure access to medical information regarding at least one subject, comprising:
at least one database configured to store subject biometric information, subject information, and user authentication information;
a first input configured to accept unique biometric information from a subject;
a second input configured to accept a command from a user for accessing at least a portion of a record associated with the subject, the record stored in the subject information database, the subject's medical record identified using the subject's biometric information stored on the subject biometric information database; and
an access device configured to allow secure access to at least the portion of the medical record using the user authentication information in response to the execution of the user's command on at least the portion of the medical record.
